(19) United States
(12) Patent Application Publication
(10) Pub. No.: US 2006/0114303 A1
(43) Pub. Date: Jun. 1, 2006

(54) Method and device for supplying printing ink to and carrying it off from a doctor blade device of the inking system of a rotary printing press and/or for cleaning the doctor blade device

(76) Inventor: Lutz Telljohann, Lengerich (DE)

Correspondence Address: JACOBSON HOLMAN PLLC, 400 SEVENTH STREET N.W., SUITE 600, WASHINGTON, DC, 20004, US

(21) Appl. No.: 10/516,526

(22) PCT Filed: May 30, 2003
(86) PCT No.: PCT/EP03/05788

§ 371 Date: Dec. 2, 2004

(30) Foreign Application Priority Data
Jun. 10, 2002 (DE) 10 25 681.0

(51) Int. Cl. B41J 2/18

(52) U.S. Cl. 347/89

(57) ABSTRACT

The invention relates to a method and a device for supplying printing ink to and carrying it off from a doctor blade device of the inking system of a rotary printing press. Said device comprises a doctor blade support provided with a linearly extending groove and with doctor blades that can be put against an inking roller or screen roller, said blades delimiting together with the inking roller and the groove an inking chamber. The device further comprises conduits and motor-driven pump devices for supplying ink to and carrying it off from the inking chamber. The motors used are preadjusted in terms of their parameters and are not modifiable during operation. If necessary, a portion of the ink from the flow of ink supplied to the doctor blade device can be carried off and/or a portion of the ink from the flow of ink carried off from the doctor blade device can be returned to the supply conduit.

The invention concerns a process and a device for supplying printing ink to and educing printing ink from a squeegee device of an inking system on a rotary printing press and for cleaning the squeegee device, which comprises a squeegee blade carrier, provided with a longitudinally running trough, with squeegee blades that are adjustable on a form inking roller that, together with the form inking roller and the trough, delimit an ink chamber, and comprise lines and pumping devices powered by motors for supplying and educing the ink or the cleaning agent into and out of the ink chamber.

A device of this type is known from the German patent DE 195 48 535 C2 with which residual ink can be removed not only from the ink chamber of the squeegee device, but also from the supply and evacuation lines while reducing the amount of dissolving agent used for cleaning, in that the ink from the ink chamber is pumped back into an ink tank via the evacuating lines, in that the dissolving agent is subsequently pumped out of a dissolving agent tank via the supply lines into the ink chamber and is channeled via the evacuating lines into the ink tank for a predetermined amount of time, in that admission into the ink tank is subsequently stopped and in that the dissolving agent still soiled by the ink is pumped into a waste tank for a predetermined amount of time, in that the supply flow of dissolving agent from the dissolving agent tank is subsequently interrupted and in that the dissolving agent still present in the circulation system is pumped into the waste tank as well, in that fresh dissolving agent is subsequently pumped via the supply lines and educing lines in a closed cleaning circuit for a predetermined amount of time and in that finally, the dissolving agent that was fed through the closed cleaning circuit is channeled into the waste tank. The known device is elaborate to the extent that an ink pump, a dissolving agent pump and two mutually connected pumps are provided for pumping ink and dissolving agent back into the ink tank or into the waste tank. The use of several pumps creates high procurement costs on the one hand.

On the other hand, it must be taken under consideration in the case of the known device that during the circulation of the ink under printing operations, a larger volume must be fed back into the ink tank than is being pumped into it, since the ink in the ink chamber becomes enriched with air. As a consequence of this, the evacuating pump must pump a larger volume than the delivery pump. This volumetric pumping ratio must be permanently monitored and readjusted manually when required.

The task of the present invention is therefore to propose a process and a device of the type initially indicated, which can manage with a number of pumps for circulating the ink and/or for cleaning with a dissolving agent or cleaning agent and for which it is not required to readjust the volumetric pumping ratio.

This task is resolved in accordance with the invention by the characteristics of patent claim 1.

Furthermore, this task is also resolved for a device of the type initially indicated in that two pumping devices are provided that are preset in their parameters, and that, when required, a portion of the ink from the ink stream supplied to the squeegee device is channeled off and/or a portion of the ink from the ink stream led away from the squeegee device is rechanneled to the squeegee device.

The underlying task of the invention is also resolved for a device of the type initially indicated in that two pumping devices are provided, of which the first pumping device, via regulating valves, suctions off ink or cleaning agent from an ink reservoir or from a cleaning agent reservoir, and pumps it into the ink chamber, and of which the second pumping device pumps an ink-air mixture from the ink chamber into the ink reservoir, or pumps cleaning agent or cleaning agent containing ink into a waste reservoir containing used cleaning agent, and that, via a regulating valve, the supply line stands in connection with a line leading to the ink reservoir, in which an adjustable throttle valve or throughflow regulating valve is arranged.

As compared to the known device, the process in accordance with the invention and the device in accordance with the invention make it possible to circulate the ink during printing operations and to clean the squeegee device with only two pumps. In order to be able to provide two pumping capacity devices according to the invention with an established efficiency ratio, then in accordance with the invention, at least one bypass must be provided that comprises a line branching out from the feed lines. Purposefully, the outbranching line channels the ink directly back into the ink tank.

Given the case, that the vacuum pump has a greater pumping capacity than the priming pump, in addition to the first bypass or in place of the first bypass, it is advantageous to provide a line that leads from the pressure side of the vacuum pump to the supply line of the squeegee chamber.

Advantageously, the bypass line branching out from the feed line and/or the line leading from the pressure side of the eduction pump to the supply side of the squeegee chamber are each respectively equipped with a cutout valve and/or with a throughflow regulating valve. The throughflow regulating valves are empirically adjusted in such a manner that, for example, a portion of the ink supplied by the priming pump is immediately recirculated into the ink tank or that the ink drawn off by the vacuum pump is made available anew to the supply side of the squeegee chamber. In this manner, it is generally ensured during printing operations that the eduction volumes and the feed volumes, and the volumes supplied to and drawn off from the ink chamber are about equal, while taking under consideration the circumstance that, in the ink chamber, the ink becomes enriched with air.

It is especially advantageous if the fill level of the ink in the squeegee chamber is monitored by a sensor and, in the event that the specified fill levels are exceeded or not attained, the throttle valves or the throughflow regulating valves are set in such a manner, via a regulated circuit, so that the fill level will again resume its status within the specified limits.

According to an especially preferred embodiment of the invention, it is provided that the two pumping devices comprise two chambers from a double diaphragm pump with only one drive shaft. Such double diaphragm pumps with separate chambers, of which the one can assume delivery and the other can assume recirculation, are sold, for example, by the ALMATEC Maschinenbau [machine building] GmbH company, in D-47475 Kamp-Lintfort. Advantageously, the two chambers of the double diaphragm pump have the same volumetric pumping capacity.

Furthermore, the feed line can be provided with a line leading to the waste tank, which features a valve and a throttle valve or a throughflow regulating valve. This line is a bypass line, through which cleaning agent pumped into the squeegee chamber during cleaning of the squeegee device can be recirculated, in order to take the circumstance into account, that during the cleaning process, the cleaning agent also becomes enriched with air so that, during the cleaning process, the volume that was recirculated out of the squeegee chamber is greater than the volume that was pumped in. Since the cleaning agent that was recirculated via the bypass line is not soiled or barely soiled, it can be advantageous to let the bypass line flow into the tank for clean cleaning agent.

Exemplary embodiments of the invention shall be more closely detailed in the following by the use of drawings, in which the device in accordance with the invention for supplying and educing printing ink to and from a squeegee device of an inking system on a rotary printing press and for cleaning the squeegee device is schematically represented.

The individual figures show:

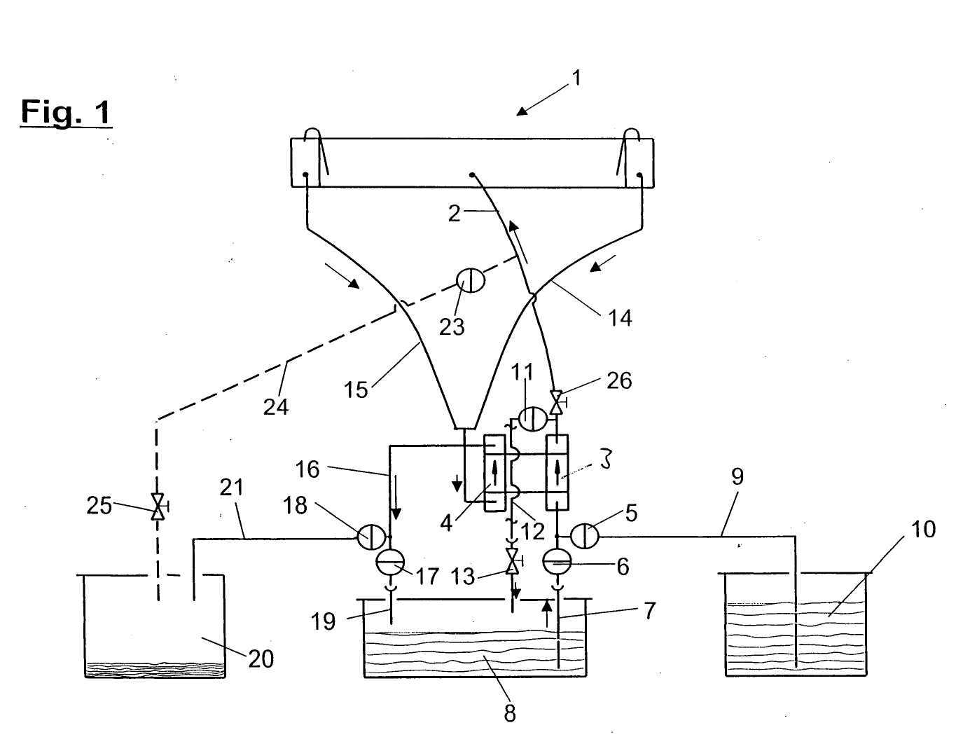

FIG. 1 Schematic representation of the device with bypass devices on the supply side

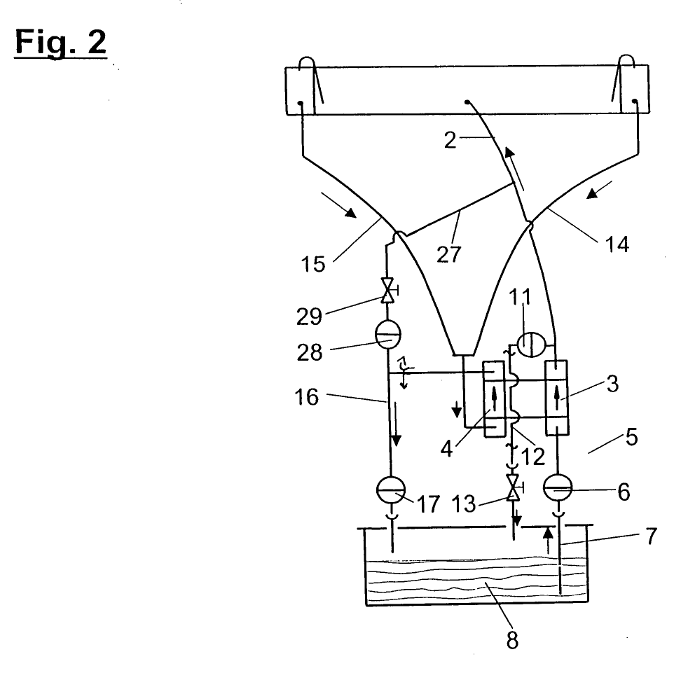

FIG. 2 Schematic representation of the device with a bypass device on the eduction side

In FIG. 1, the device shown in accordance with the invention is designed for the case in which the pumping capacity of the pump chamber 3 is equal or greater than the pumping capacity of the pump chamber 4. Into the central section of the ink chamber, which is a component part of the squeegee device 1, a feed line 2 flows in that is connected to the delivery side of a pump chamber 3 of the double diaphragm pump 3, 4. The suction side of the pump chamber 3 of the double diaphragm pump 3, 4 can, via the line shutoff valves or the cutout valves 5, 6, either be connected to the suction line 7, which flows into the ink tank 8, or connected to the suction line 9, which flows into the tank 10 for clean cleaning agent.

Connected to the feed line 2, via the line shutoff valve or the cutout valve 11, is a line 12, in which an adjustable throttle valve or throughflow regulating valve 13 is arranged. A throttle valve 25 can also be provided in the feed line 2.

The suction side of the second pump chamber 4 of the double diaphragm pump 3, 4 is connected to the recirculation lines 14, 15, which are connected on the sides of the ink chamber of the squeegee device 1. The pressure side of the second pump chamber 4 of the double diaphragm pump 3, 4 is connected to a line 16, which, via line shutoff valves or cutout valves 17, 18, can be connected to a line 19 leading to the ink tank 8, or can be connected to a line 21 that flows into the waste tank 20 for used cleaning agent.

Another line 24 can be connected, via the line shutoff valve or the cutout valve 23, to the feed line 2, in which an adjustable throttle valve or throughflow regulating valve 25 is arranged and which flows into the waste tank 20.

Upon starting the printing operation and during the printing operation, valve 5 finds itself closed in its basic state. Via the suction line 7 and via valve 6, which is open in its basic state, ink is delivered into the ink chamber of the squeegee device 1 through the pump chamber 3 of the double diaphragm pump 3, 4 and through the feed line 2. During the printing operation, printing ink or printing ink enriched with air is pumped back into the ink tank 8 via the recirculation lines 14, 15 and via the second pump chamber 4 of the double diaphragm pump 3, 4, via the line 16 and the valve 17, with valve 18 being closed. Since the pump chamber 3 of the double diaphragm pump 3, 4 has an equal or greater volumetric capacity than pump chamber 4, and the recirculated ink, in spite of the reduction in ink due to the material printed, exhibits a greater volume due to its enrichment with air than does the ink delivered through the feed line 2, a partial quantity of the printing ink is pumped back, during the printing operation, into the ink tank 8 with valve 11 open and through line 12 and through the throttle valve 13, so that the pumping ratio between the two pump chambers 3, 4 matches the volumes pumped.

When cleaning the ink chamber and the lines channeling the printing ink, the valve 6 is closed, and while valve 5 is open, via the line 9, clean cleaning agent is suctioned from tank 10 and is channeled into the ink chamber via the feed line 2, with valve 11 closed. During this cleaning process, initially, the ink that can still be displaced by the cleaning agent via valve 18 and via line 19, with valve 18 closed, is channeled into the ink tank 8. However, as soon as the ink is diluted by the solvent, valve 17 is closed and valve 18 is opened, and the cleaning agent or solvent rendered impure with the ink is channeled into the waste tank 20 via line 21. Since the cleaning agent also becomes enriched with air in the ink chamber during the cleaning process, a line 24 can be connected to the feed line 2 via valve 23, in which the adjustable throttle and throughflow regulating valve 25 is arranged and which flows into the waste tank 20. As soon as this occurs, cleaning agent can be channeled into the waste tank via this line 24 in order to take the circumstance into account that the cleaning agent that is recirculated through lines 14, 15 is enriched with air. To the extent that clean cleaning agent could be branched out from the feed line 2, line 24 could also be made to flow into the tank 10 for clean cleaning agent.

FIG. 2 shows another preferred form of embodiment of the invention, wherein the representation of the cleaning agent tank and of the cleaning agent lines has been omitted for reasons of gaining a clear overview. In the event that pump chamber 4 of the double diaphragm pump 3, 4 should display a volumetric capacity that is substantially greater than pump chamber 3, a portion of the ink pumped out from feed line 2 must be led back through the recirculation line 27. A throttle valve or a throughflow regulating valve 29 is provided for regulating the return flow. Furthermore, another cutout valve 28 can be provided that is closed when the ink is to be pumped out of the ink chamber.

Of course, the bypass 27, 28, 29 represented in FIG. 2 can also be integrated into the device in accordance with FIG. 1.

1: Process for supplying printing ink to and educing printing ink from a squeegee device (1) of an inking system on a rotary printing press, which comprises a squeegee blade carrier, provided with a longitudinally running trough, with squeegee blades that are adjustable on a form inking roller or on an anilox roller, which, together with the form inking roller and the trough, delimit an ink chamber, and comprise lines and pumping devices (3, 4) powered by motors for supplying and educing the ink into and out of the ink chamber, thus characterized that motors are used whose parameters have been preset and which do not change during operation of the motors and that, when required, a portion of the ink from the ink stream supplied to the squeegee device is channeled off and/or a portion of the ink from the ink stream led away from the squeegee device is rechanneled to the feed line (2).

2: Device for implementing the process in accordance with claim 1, thus characterized that at least one line (12) branches off from the feed line (2).

3: Device in accordance with claim 2, thus characterized that the line (12) leads back to the ink tank (8).

4: Device for implementing the process in accordance with claim 1, thus characterized that at least one line (27) leads from the pressure side of the vacuum pump (4) to the feed line (2) of the squeegee device (1).

5: Device in accordance with claim 2, thus characterized that a throughflow regulating valve (13, 26, 29) and/or a cutout valve (11, 28) is arranged in at least one line (2, 12, 27).

6: Device in accordance with claim 5, thus characterized that, for monitoring the quantity of ink present in the squeegee device (1), a sensor is provided whose signals are processed through a closed loop control circuit that regulates the throughflow regulating valve (13, 26, 29) in such a manner that the quantity of ink circulating in the squeegee device (1) is always maintained within specified limits.

7: Device for implementing the process in accordance with claim 1, thus characterized that the two pumping devices (3, 4) comprise two chambers of a double diaphragm pump with only one drive shaft.
